(19) United States
(12) Patent Application Publication
(10) Pub. No.: US 2010/0224728 A1
(43) Pub. Date: Sep. 9, 2010

(54) Interior trim component for an aircraft cabin

(75) Inventors: Markus Feiler, Stuttgart (DE); Bernd Veihelmann, Heilbronn (DE); Dietmar Voelkle, Biberach (DE)

Correspondence Address: KRIEG DEVAULT LLP, ONE INDIANA SQUARE, SUITE 2800, INDIANAPOLIS, IN, 46204-2079, US

(73) Assignee: AIRBUS OPERATIONS GMBH

(21) Appl. No.: 12/532,568

(22) PCT Filed: Mar. 25, 2008
(86) PCT No.: PCT/EP2008/002355

§ 371 Date: Mar. 15, 2010

Related U.S. Application Data
(60) Provisional application No. 60/896,312, filed on Mar. 22, 2007.

(30) Foreign Application Priority Data
Mar. 22, 2007 (DE) 10 2007 013 819.0

(51) Int. Cl. B64C 1/06; B32B 37/00; B29C 65/62; B29C 65/48; B23P 11/00

(52) U.S. Cl. 244/119; 156/60; 156/93; 29/428

(57) ABSTRACT

An interior trim component (10) for an aircraft cabin comprises a supporting structure which is formed by a first chamber system (12) which is sealable against the outside atmosphere. The first chamber system (12) forming the supporting structure is adapted to be loaded with an internal pressure which is necessary for producing the desired structural load-bearing capacity of said supporting structure.

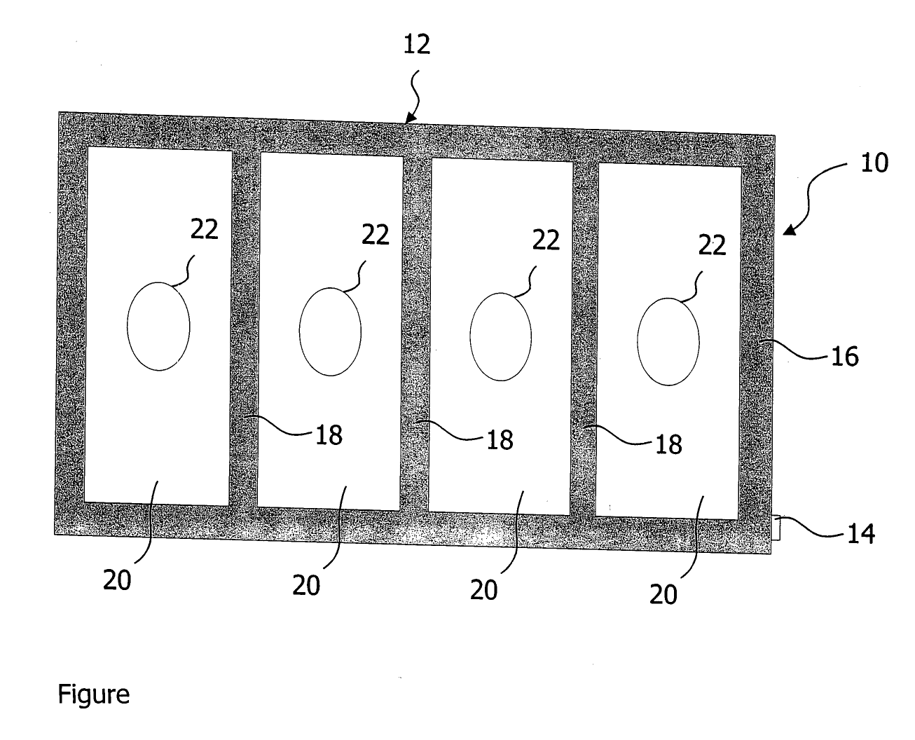

The invention relates to an interior trim component for an aircraft cabin, a method of manufacturing an interior trim component of this kind, and a method of mounting an interior trim component of this kind in an aircraft.

Elements which are currently used as interior trim components in an aircraft cabin comprise a basic structure which is adapted to their intended application as panelling for the sides, doorframe panelling, ceiling panelling, luggage compartment components or the like, and which is usually constructed as a sandwich/honeycomb structure and consists, for example, of a fibrous composite material. The basic structure is designed in each case, as regards its structural mechanics, in dependence upon the loadings on the interior trim components resulting from the pressure of decompression and from the manual loads at their corresponding point of installation in the aircraft cabin. In order to impart the necessary surface quality to an interior trim component, the basic structure undergoes a manual surface treatment by smoothing or polishing and is then either painted or bonded to a decorative laminate. The interior trim components which have been painted or bonded to a decorative laminate are finally fastened to the aircraft structure by means of discrete mounting arrangements, the maximum dimensions of the components being determined by the requirement that they have to be transported into the aircraft cabin through the doors for installation.

The production of interior trim components which are currently used in an aircraft cabin is time-intensive and expensive because of the costs of the production plants needed for manufacturing them and also because of the high component of manual activity in their design and production. As a result of this, the individual wishes of customers regarding the design of the interior cabin trim can often be translated into reality at justifiable expense only to a qualified extent.

The underlying object of the invention is to make available an interior trim component for an aircraft cabin which is simple and cost-effective to manufacture, a method of manufacturing an interior trim component of this kind, and a method of installing an interior trim component of this kind in an aircraft.

This object is achieved by means of an interior trim component having the features of claim 1, a method of manufacturing an interior trim component, which method has the features of claim 13, and a method of installing an interior trim component in an aircraft, which method has the features of claim 23.

The interior trim component for an aircraft cabin according to the invention comprises a supporting structure which is formed by a first chamber system which is sealable against the outside atmosphere. The first chamber system forming the supporting structure is adapted to be loaded with an internal pressure which is necessary for producing the desired structural load-bearing capacity of said supporting structure. In the case of the interior trim component according to the invention, the structural load-bearing capacity of the supporting structure is therefore not produced by the structural design or the material of the component, but by the internal pressure introduced into the first chamber system forming said supporting structure. It is therefore possible, in the case of the interior trim component according to the invention, to dispense with a load-bearing supporting structure is which is constructed, for example, as a sandwich/honeycomb structure. Consequently, the interior trim component according to the invention is particularly simple to manufacture in a cost-effective manner. In addition, the interior trim component according to the invention is distinguished by a particularly low weight.

The first chamber system of the interior trim component according to the invention which forms the supporting structure can be adapted in a relatively simple manner to the geometry of the component, and the application specific requirements regarding the load-bearing capacity of the supporting structure formed by the first chamber system. The geometry of the interior trim component can thus be varied without great expense. Consequently, individual wishes of customers regarding the interior trim of the aircraft cabin which entail varying the geometry of the interior trim components of said aircraft cabin can be put into practice quickly and at justifiable expense. The interior trim component according to the invention can be used in the aircraft cabin as panelling for the sides, doorframe panelling, ceiling panelling or the like. In addition, however, it is also conceivable to equip the interior trim component according to the invention with a suitably designed supporting structure, and to use it for components which are subjected to higher mechanical loads, such as, for example, luggage compartment components or the like.

A further advantage of the interior trim component according to the invention consists in the fact that, when the first chamber system that forms the supporting structure of the interior trim component is in the non-pressurized condition, said component can be “folded up” into a relatively small volume and transported into the aircraft cabin through the door of the latter. The maximum size of an interior trim component according to the invention is thus normally not limited by the requirement of having to transport the component into the aircraft cabin through the door of the latter, but merely by the weight of the component and its manipulability. It is thereby possible, in advantageous manner, to reduce the number of interior trim components to be installed in an aircraft cabin, which results in reduced expenditure when placing the components in position during installation, and thus in lower installation costs overall.

Finally, additional systems, such as air-conducting lines or cable ducts for electric lines for example, can be easily integrated into the interior trim component according to the invention. The installation of these additional systems in the aircraft cabin can thereby be made distinctly easier.

The first chamber system forming the supporting structure of the interior trim component according to the invention preferably has a pressurising connection which is connectable to an external compressor or to a pressure source on the aircraft. The first chamber system can be easily loaded, via the pressurising connection, with the internal pressure necessary for producing the desired structural load-bearing capacity of the supporting structure. If desired, the internal pressure introduced into the first chamber system can be actively varied in order to thereby bring about a change in the shape of the supporting structure and thus of the interior trim component. However, the internal pressure introduced into said first chamber system is preferably chosen in such a way that the surface of the interior trim component does not feel hard, but is distinguished by soft-to-the-touch properties.

The pressurising connection of the first chamber system forming the supporting structure is preferably designed in such a way that it can be sealed after the introduction of the desired internal pressure into the first chamber system, in order to seal the latter off from the outside atmosphere. However, the sealing of the pressurising connection is preferably reversible, so that renewed pressurisation of the first chamber system can take place if necessary. It is thereby possible to bring about changes in the shape of the component, or to compensate for pressure losses in the first chamber system, even at a later point in time during the period of use of the interior trim component according to the invention in an aircraft. In particular, the pressurising connection is preferably designed in such a way that it permits active variation of the internal pressure within the first chamber system, in order to adapt said pressure to, for example, the pressure in the aircraft cabin which varies when the aircraft is in service.

The interior trim component according to the invention also preferably has at least one section which is supported by the supporting structure and is formed by a second chamber system connected to said supporting structure or by a membrane connected to the supporting structure. Apertures for windows, doors or the like may, for example, be incorporated in the second chamber system or membrane, without to jeopardising the reliable sealing-off of the first chamber system from the ambient atmosphere. The second chamber system may, if necessary, be loaded with an internal pressure which differs from the internal pressure introduced into the first chamber system. As an alternative to this, however, the second chamber system may also be loaded with the same internal pressure as the first chamber system.

The first chamber system forming the supporting structure, and/or the at least one section of the interior trim component that is supported by said supporting structure, preferably consist(s) of a gastight material. The use of a gastight material for the first chamber system forming the supporting structure, and/or for the at least one section of the interior trim component that is supported by said supporting structure, ensures that the internal pressure introduced into the first chamber system cannot escape from the first chamber system, and thus that the desired structural load-bearing capacity of the supporting structure formed by the first chamber system can be maintained.

The first chamber system forming the supporting structure, and/or the at least one section of the interior trim component according to the invention that is supported by said supporting structure, preferably consist(s) of a drapable material which is, for example, cloth-like. The interior trim component according to the invention is then particularly easy to handle and install, since it can be satisfactorily adapted, particularly in the non-pressurised state, to the curved contour of the aircraft structure.

The first chamber system forming the supporting structure, and/or the at least one section of the interior trim component that is supported by said supporting structure, may consist of a fibre-reinforced material in order to impart the desired mechanical properties to the interior trim component according to the invention. As the reinforcing fibres, use may be made, for example, of short fibres or continuous fibres made of glass, carbon, aramide or a thermoplastic material such as, for example, polyetherimide or polybenzoxazol.

In a particularly preferred embodiment of the interior trim component according to the invention, the first chamber system forming the supporting structure, and/or the at least one section of the interior trim component that is supported by said supporting structure, consist(s) of a material which comprises reinforcing fibres incorporated locally in the material. Said reinforcing fibres are preferably incorporated in the material of the first chamber system forming the supporting structure, and/or the at least one section of the interior trim component that is supported by said supporting structure, along load paths. The interior trim component according to the invention can then be adapted in a particularly satisfactory manner to those demands on the mechanical properties of the component which are specific to the application, and yet said component can be designed in a cost-effective and light-weight manner.

The first chamber system of the interior trim component which forms the supporting structure is preferably filled, at least partially, with a thermosetting foam material. The foam material introduced into the first chamber system is preferably thermosettable at room temperature and imparts stability to the supporting structure, without it being necessary to maintain the internal pressure introduced into the first chamber system throughout the entire period of use of the interior trim component. An interior trim component which has a supporting structure which is at least partially filled with a thermosetting foam material can be used in a particularly satisfactory manner as a component which is subjected to higher mechanical loads, for example as a luggage compartment component or the like.

One preferred embodiment of the interior trim component according to the invention comprises a surface layer which is applied to the first chamber system forming the supporting structure, and/or to the at least one section of the interior trim component that is supported by said supporting structure. The surface layer may consist of a foil or a textile material and impart the desired decorative design to the interior trim component. Said surface layer may therefore be dyed in the desired colour or provided with a desired surface structure. As an alternative to this, however, the material of the first chamber system forming the supporting structure, and/or of the at least one section of the interior trim component that is supported by said supporting structure, may also already be dyed in a desired colour or have a desired surface structure. It is then possible to dispense with a surface layer without having to accept restrictions with respect to the decorative design of the interior trim component.

In order to produce a surface which is resistant to penetration, the surface layer of the interior trim component according to the invention preferably consists of a fibre-reinforced material. As the reinforcing fibres, use may be made, once again, of short fibres or continuous fibres made of glass, carbon, aramide or a thermoplastic material such as, for example, polyetherimide or polybenzoxazol (PBO). The reinforcing fibres may be distributed within the surface layer, or be concentrated locally in certain regions of said layer which are, for example, subjected to particularly high mechanical loads.

The surface layer preferably consists of the same material as the first chamber system forming the supporting structure, and/or the at least one section of the interior trim component that is supported by said supporting structure. Said surface layer can then be particularly easily connected to the first chamber system forming the supporting structure, and/or to the at least one section of the interior trim component according to the invention that is supported by said supporting structure. In addition, an interior trim component which is configured in this way is distinguished by high structural integrity.

The interior trim component according to the invention preferably comprises a fastening device for fastening the interior trim component to an aircraft structure. Said fastening device may be designed in such a way that it is possible to avoid the introduction of loads into the interior trim component at certain points, such as results from the fastening of a known interior trim component to an aircraft structure by means of discrete mounting arrangements. Fastening devices such as, for example, zip fasteners or hook-and-loop fasteners are particularly advantageous. As an alternative to this, however, the interior trim component according to the invention can also be connected to the structure of the aircraft in a form-locking manner at certain points.

A method according to the invention for manufacturing an interior trim component for an aircraft cabin comprises the steps of preparing a first layer of material, connecting a second layer of material to said first layer of material so that a supporting structure is produced which is formed by a first chamber system which is sealable against the outside atmosphere, and loading said first chamber system with an internal pressure which is necessary for producing the desired structural load-bearing capacity of said supporting structure. The first and/or second layer(s) of material may be manufactured by current processes, such as, for example, extrusion, braiding, embroidery or the like, which are known from plastics technology or textiles technology. The interior trim component can be manufactured in a particularly simple and cost-effective manner by producing the first chamber system that forms the supporting structure of the interior trim component by means of first and second layers of material that are to connected to one another.

The first and second layers of material are preferably connected to one another by stitching, gluing or welding or by a combination of these joining methods. All that is essential is that the joining method used makes it possible to produce the first chamber system which is sealable against the outside atmosphere and be loaded with the desired internal pressure and can then also hold said internal pressure, at least for a desired time span. It is therefore also conceivable to additionally seal off joining seams between the first and second layers of material.

The first and second layers of material are preferably shaped in such a way, and are preferably connected to one another in such a way, that at least one section of the interior trim component which is supported by the supporting structure is produced. That section of the interior trim component which is supported by the supporting structure may be formed by a second chamber system which is connected to said supporting structure, or by a membrane which is connected to the supporting structure. It is possible to incorporate, for example, window apertures, door apertures or the like in that section of the interior trim component which is supported by the supporting structure, under which circumstances the incorporation of the apertures in that section of the interior trim component which is supported by the supporting structure may take place before or after the first and second layers of material are connected.

The first layer of material may be formed by joining together a plurality of first material layer sections. In a similar way, the second layer of material may be formed by joining together a plurality second material layer sections. The first material layer sections are preferably connected to one another for the purpose of forming the first layer of material, before the second layer of material is connected to the first layer of material. In a similar way, the second material layer sections are preferably connected to one another before the second layer of material is connected to the first layer of material. The first and/or second material layer sections, or even the entire first and/or second layer(s) of material, can be brought into the desired shape with the aid of cutting patterns. As an alternative to this, the first and/or second material layer sections, or even the entire first and/or second layer(s) of material, can be manufactured with the aid of tool moulds having the desired geometry.

Reinforcing fibres, such as, for example, short fibres or continuous fibres made of glass, carbon, aramide or a thermoplastic material such as, for example, polyetherimide or polybenzoxazol (PBO) may be incorporated in the first and/or second layer(s) of material in dependence upon those demands on the mechanical properties of the interior trim component which are specific to the application. In addition to this, or as an alternative to this, reinforcing fibres may also be disposed between the first and second layers of material.

Basically, the reinforcing fibres may be distributed within the first and/or second layer(s) of material and/or between said first and second layers. However, said reinforcing fibres are preferably incorporated in the first and/or second layer(s) of material, and/or between said first and second layers, locally along load paths. The interior trim component may then be adapted in a particularly satisfactory manner to the mechanical requirements specific to the application, when said component is used in an aircraft cabin.

That first chamber system of the interior trim component which forms the supporting structure is preferably filled, at least partially, with a thermosetting foam material. The foam material used is preferably a reactive light-weight foam material which is thermosettable at room temperature and is introduced into the first chamber system of the interior trim component via an aperture which can be sealed off after the filling operation. The first chamber system of the interior trim component is preferably initially inflated by means of an external compressor or by means of a pressure source on the aircraft, and thereby brought into the desired shape. The cavities of the first chamber system may then be filled with the foam material. When the foam material has set, the external compressor or the pressure source on the aircraft may be disconnected from the pressurising connection of the first chamber system, without the first chamber system losing its dimensional stability.

A surface layer, which consists, for example, of a foil or a textile material, is preferably applied to the first chamber system forming the supporting structure, and/or to the at least one section of the interior trim component that is supported by said supporting structure. The surface layer may be dyed or provided with a desired surface structure and be connected to the first chamber system forming the supporting structure, and/or to the at least one section of the interior trim component that is supported by said supporting structure by stitching, gluing or welding or by a combination of these joining methods.

Reinforcing fibres, such as, for example, short fibres or continuous fibres made of glass, carbon, aramide or a thermoplastic material such as, for example, polyetherimide or polybenzoxazol (PBO) are preferably incorporated in the surface layer in order to produce a surface of the interior trim component which is resistant to penetration. The fibres may be distributed within the surface layer or be concentrated locally in regions of said layer which are subjected to particularly high mechanical loads.

Finally, a fastening device for fastening the interior trim component to the aircraft structure is preferably attached to said component. The fastening device, which is constructed, for example, in the form of a zip fastener or a hook-and-loop fastener, may be connected to the interior trim component, for example by stitching or in some other suitable way.

The method according to the invention for installing an interior trim component for an aircraft cabin in an aircraft comprises the steps of preparing an interior trim component having a supporting structure which is formed by a first chamber system which is sealable against the outside atmosphere, fastening said interior trim component to an aircraft structure, and loading the first chamber system forming the supporting structure with an internal pressure which is necessary for producing the desired structural load-bearing capacity of said supporting structure. In the case of the method of installation according to the invention, the interior trim component is thus attached to the aircraft structure when the first chamber system is in the non-pressurised state. The interior trim component is thus particularly easy to handle when being transported into the aircraft cabin through the cabin door and when being fastened to the aircraft structure, and can be easily adapted to the curved contour of the aircraft structure.

The first chamber system is preferably loaded with pressure by means of an external compressor or a pressure source on the aircraft, which compressor or pressure source can be connected to a pressurising connection of the first chamber system after the interior trim component has been fastened to the aircraft structure.

A preferred embodiment of the present invention will be explained in greater detail below with the aid of the appended single drawing, which shows a diagrammatic representation of a preferred embodiment of an interior trim component for an aircraft cabin according to the invention.

The FIGURE shows an interior trim component 10 for an aircraft cabin, which comprises a supporting structure formed by a first chamber system 12 which is sealable against the outside atmosphere. The first chamber system 12 has a pressurising connection 14 which is connectable to an external compressor, or to a pressure source on the aircraft, in order to load the first chamber system 12 with an internal pressure which is necessary for producing the desired structural load-bearing capacity of the supporting structure formed by said first chamber system 12.

In the case of the interior trim component 10 shown in the FIGURE, the supporting structure formed by the first chamber system 12 comprises a frame 16 which surrounds said interior trim component 10, and also a plurality of crosspieces 18 which extend, essentially parallel with one another, between mutually opposite sides of the frame 16. In addition to the first chamber system 12, the interior trim component 10 comprises four sections 20 which are connected to the supporting structure formed by the first chamber system 12, and are formed by a second chamber system. As an alternative to this, the sections 20 of the interior trim component 10 may also consist of a membrane. All that is essential is that the first chamber system 12 forming the supporting structure of the interior trim component 10 is sealed off from those sections 20 of said interior trim component which are supported by the supporting structure. Window cut-outs 22 are incorporated in the sections 20 of the interior trim component 10.

The first chamber system 12 forming the supporting structure of the interior trim component 10, and also the sections 20 of said interior trim component 10 which are connected to said first chamber system 12, consist of a gastight, drapable material in which continuous reinforcing fibres made of glass, carbon, aramide or a thermoplastic material such as, for example, polyetherimide or polybenzoxazol (PBO) are incorporated locally, i.e. in regions of the interior trim component 10 which are subjected to particularly high mechanical loads.

In order to improve the structural stability of the interior trim component 10, the first chamber system 12 forming the supporting structure of said component is filled with a foam material. In addition, the interior trim component 10, i.e. the first chamber system 12 forming the supporting structure, and also the sections 20 of the interior trim component 10 which are supported by said supporting structure, are provided with a surface layer which is bonded to the surface of said interior trim component 10. The surface layer consists of the same material as the first chamber system 12 and the sections 20 of the interior trim component 10, but is dyed in a desired colour and provided with a desired surface structure. In addition, reinforcing fibres made of glass, carbon, aramide or a thermoplastic material such as, for example, polyetherimide or polybenzoxazol (PBO) are incorporated in the surface layer in order to preclude the possibility of said surface layer being penetrated if the surface of the interior trim component 10 is subjected to the effect of a force.

Finally, the interior trim component 10 has a fastening device which is not shown in the FIGURE but is constructed in the form of a zip fastener or a hook-and-loop fastener, and by means of which the interior trim component 10 can be fastened to an aircraft structure.

For the purpose of manufacturing the interior trim component 10 shown in the FIGURE, a plurality of first material layer sections, which are shaped in accordance with a cutting pattern or by means of a tool, are connected to form a first layer of material. The interior trim component 10 shown in the FIGURE may, for example, comprise a first layer of material which is formed from four first material layer sections which each have a window cut-out 22. In similar manner, a second layer of material is produced by the connection of four second material layer sections. The second material layer sections of the interior trim component 10 shown in the FIGURE each comprise, in a manner similar to the first material layer sections, a window cut-out 22. In order to form the first and second layers of material, the first and second material layer sections are connected by gluing, stitching or welding or by a combination of these joining methods.

In a next step, the first layer of material is connected to the second layer of material by stitching, gluing or welding or by a combination of these joining methods, in such a way that the supporting structure formed by the first chamber system 12, and also the sections 20 supported by said supporting structure, are produced. For this purpose, the first and second layers of material are connected to one another in a laminar manner in the region of the sections 20 of the interior trim component 10. In addition, a connecting seam extending along an outer edge of the interior trim component 10 is produced between the first and second layers of material. If necessary, this connecting seam may be additionally sealed off in order to ensure that an internal pressure introduced into the first chamber system 12 cannot escape from the latter.

The first and second layers of material for forming the interior trim component 10 may be manufactured by production processes such as, for example, extrusion, braiding, embroidery or the like, which are known from plastics technology or textiles technology. The reinforcing fibres made of glass, carbon, aramide or a thermoplastic material such as, for example, polyetherimide or polybenzoxazol (PBO) may be incorporated in the first and second layers of material in a uniformly distributed or locally concentrated manner, before the first and second layers of material are connected to one another. As an alternative to this, however, it is also possible, when connecting the first and second layers of material, to incorporate between the first and second layers of material reinforcing fibres which are distributed or locally concentrated.

Finally, the interior trim component 10 is bonded to the desired surface layer and provided with the pressurising connection 14, an aperture for filling the first chamber system 12 with the foam material, and the fastening device for fastening the component 10 to the aircraft structure.

When installing the interior trim component 10 in the aircraft cabin, said component 10 is first of all attached to the aircraft structure by means of the fastening device. An external compressor or a pressure source on the aircraft is then connected to the pressurising connection 14 and the first chamber system 12 is loaded with an internal pressure which is necessary for producing the desired structural load-bearing capacity of the supporting structure formed by said first chamber system 12. When the interior trim component 10 has reached the desired shape as a result of the introduction of the desired internal pressure into the first chamber system 12, a reactive light-weight foam material which is thermosettable at room temperature is introduced into said first chamber system 12 via the filling aperture, which is not shown in the FIGURE. In the process, surplus foam material can be accommodated in an overflow cavity disposed at a suitable position in the interior trim component 10. When the foam material has set, the external compressor or the pressure source on the aircraft is disconnected from the pressurising connection 14. Finally, the pressurising connection 14, and also the filling aperture in the first chamber system 12 for the foam, are sealed.

1. Aircraft cabin interior trim component (10) comprising:
a frame-shaped supporting structure formed by a first chamber system (12) which is sealable against the outside atmosphere, wherein the first chamber system (12) forming the supporting structure is adapted to be loaded with an internal pressure which is necessary for producing the desired structural load-bearing capacity of said supporting structure, and
at least one section (20) which is supported by the frame-shaped supporting structure and which extends between portions (16, 18) of the frame-shaped supporting structure.

2. Interior trim component according to claim 1,
characterised in that the first chamber system (12) forming the supporting structure has a pressurising connection (14) which is connectable to an external compressor or to a pressure source on the aircraft.

3. Interior trim component according to claim 1,
characterised in that the at least one section (20) which is supported by the supporting structure is formed by a second chamber system connected to said supporting structure or by a membrane connected to said supporting structure.

4. Interior trim component according to claim 1,
characterised in that the first chamber system (12) forming the supporting structure and/or the at least one section (20) of the interior trim component (10) that is supported by said supporting structure consist(s) of a gastight material.

5. Interior trim component according to claim 1,
characterised in that the first chamber system (12) forming the supporting structure and/or the at least one section (20) of the interior trim component (10) that is supported by said supporting structure consist(s) of a drapable material.

6. Interior trim component according to claim 1,
characterised in that the first chamber system (12) forming the supporting structure and/or the at least one section (20) of the interior trim component (10) that is supported by said supporting structure consist(s) of a fibre-reinforced material.

7. Interior trim component according to claim 6,
characterised in that the first chamber system (12) forming the supporting structure and/or the at least one section (20) of the interior trim component (10) that is supported by said supporting structure consist(s) of a material which comprises reinforcing fibres incorporated locally in said material.

8. Interior trim component according to claim 1,
characterised in that the first chamber system (12) forming the supporting structure is filled, at least partially, with a thermosetting foam material.

9. Interior trim component according to claim 1,
characterised by a surface layer which is applied to the first chamber system (12) forming the supporting structure and/or to the at least one section (20) of the interior trim component (10) that is supported by said supporting structure.

10. Interior trim component according to claim 9,
characterised in that the surface layer consists of a fibre-reinforced material.

11. Interior trim component according to claim 9,
characterised in that the surface layer consists of the same material as the first chamber system (12) forming the supporting structure and/or the at least one section (20) of the interior trim component (10) that is supported by said supporting structure.

12. Interior trim component according to claim 1,
characterised by a fastening device for fastening the interior trim component (10) to an aircraft structure.

13. Method of manufacturing an aircraft cabin interior trim component (10), which method comprises:
providing a first layer of material;
connecting a second layer of material to said first layer of material, so that a frame-shaped supporting structure is produced which is formed by a first chamber system (12) which is sealable against the outside atmosphere; and
loading said first chamber system (12) with an internal pressure which is necessary for producing the desired structural load-bearing capacity of said supporting structure, wherein the first and second layers of material are shaped in such a way, and are connected to one another in such a way, that at least one section (20) of the interior trim component (10) which is supported by the frame-shaped supporting structure and which extends between portions (16, 18) of the frame-shaped supporting structure is produced.

14. Method according to claim 13,
characterised in that the first and second layers of material are connected to one another by stitching, gluing or welding or by a combination of these joining methods.

15. Method according to claim 13,
characterised in that the at least one section (20) which is supported by the supporting structure is formed by a second chamber system, which is connected to said supporting structure and is not to be loaded with an internal pressure, or by a membrane which is connected to said supporting structure.

16. Method according to claim 13,
characterised in that the first and/or the second layer(s) of material is/are formed by joining a plurality of first and/or second material layer sections.

17. Method according to claim 13,
characterised in that reinforcing fibres are incorporated in the first and/or the second layer(s) of material and/or between said first and second layers of material.

18. Method according to claim 13,
characterised in that the reinforcing fibres are incorporated locally in the first and/or second layer(s) of material and/or between said first and second layers of material.

19. Method according to claim 13,
characterised in that the first chamber system (12) forming the supporting structure is filled, at least partially, with a thermosetting foam material.

20. Method according to claim 13,
characterised in that a surface layer is applied to the first chamber system (12) forming the supporting structure and/or to the at least one section (20) of the interior trim component (10) that is supported by said supporting structure.

21. Method according to claim 20,
characterised in that reinforcing fibres are incorporated in the surface layer.

22. Method according to claim 13,
characterised in that a fastening arrangement for fastening the interior trim component to an aircraft structure is attached to said interior trim component (10).

23. Method of installing an aircraft cabin interior trim component (10) in an aircraft, which method comprises:
preparing an interior trim component (10) having a frame-shaped supporting structure which is formed by a first chamber system (12) which is sealable against the outside atmosphere, and at least one section (20) which is supported by the frame-shaped supporting structure and which extends between portions (16, 18) of the frame-shaped supporting structure;
fastening the interior trim component (10) to an aircraft structure; and
loading the first chamber system (12) which forms the supporting structure with an internal pressure which is necessary for producing the desired structural load-bearing capacity of said supporting structure.

24. Method according to claim 23,
characterised in that the first chamber system (12) forming the supporting structure is loaded, by means of an external compressor or a pressure source on the aircraft, with the internal pressure which is necessary for producing the desired structural load-bearing capacity of said supporting structure.
